(19) United States
(12) Patent Application Publication
(10) Pub. No.: US 2004/0070683 A1
(43) Pub. Date: Apr. 15, 2004

(54) System and method for intelligent strobe charging

(76) Inventors: Miles K. Thorland, Fort Collins, CO (US); Norman C. Pyle, Greeley, CO (US); Mark John Bianchi, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/271,840

(22) Filed: Oct. 15, 2002

(51) Int. Cl. H04N 5/222

(52) U.S. Cl. 348/371

(57) ABSTRACT

A strobe or flash that charges the strobe capacitor dependent on the measured light and strobe use model can improve the battery life in a portable device. The scene illumination is measured and the current charge level of the strobe capacitor is measured. If the scene needs more light than the charge can supply, then a charge process is started. The rate of charge is dependent on the amount of additional illumination needed for the scene and the difference between the current charge level and the required charge level of the strobe capacitor.

### FIELD OF THE INVENTION

The field of this invention relates to strobe lights and more specifically to a strobe light that adjusts its charge rate dependent on the current scene conditions and the current use model of the strobe.

### BACKGROUND OF THE INVENTION

Digital imaging devices typically have a strobe or electronic flash to add illumination to a scene. In many digital imaging devices, the scene illumination, or brightness, is measured using the photo-sensor in the digital imaging device. The measured scene illumination is used to set the exposure time of the photo-sensor, the aperture of the lens system, and the intensity of the flash when the flash is used. Some digital imaging devices have multiple modes of operation for the flash. In one operating mode the flash always fires, independent of the illumination in the scene. This mode may be referred to as the strobe “forced on” mode. In another mode, the strobe may or may not fire, and the amount of energy used may vary, depending on the measured scene brightness. For example, in a moderately bright scene, the strobe may fire and use only 20% of the energy available.

Most strobe lights use an energy storage device to power the flash tube of the strobe. A typical energy storage device for a strobe is a capacitor. The energy storage device of the strobe contained in a digital imaging device is typically charged from the power system of the digital imaging device. Most digital imaging devices use batteries for their power systems. Charging the capacitor in a strobe from the batteries in a digital camera may be one of the larger loads on the batteries. Today, digital imaging devices typically charge the capacitor for the strobe at the same rate independent of the operating mode of the strobe. This may create more stress on the batteries than needed.

There is a need for a system that can vary the charge rate of the strobe energy storage device dependent on the mode of operation of the strobe and on the current scene brightness.

### SUMMARY OF THE INVENTION

A strobe or flash that charges the strobe capacitor dependent on the measured light and strobe use model can improve the battery life in a portable device. The light in the scene is measured and the charge present in the strobe capacitor is measured. If the scene needs more light than can be produced with the charge in the capacitor, then a charging process is started. The rate of charge is dependent on the difference between the current charge level and the required charge level in the strobe capacitor.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a block diagram of a digital imaging device.

FIG. 2 is a flow chart for charging a strobe light in accordance with one embodiment of the present invention.

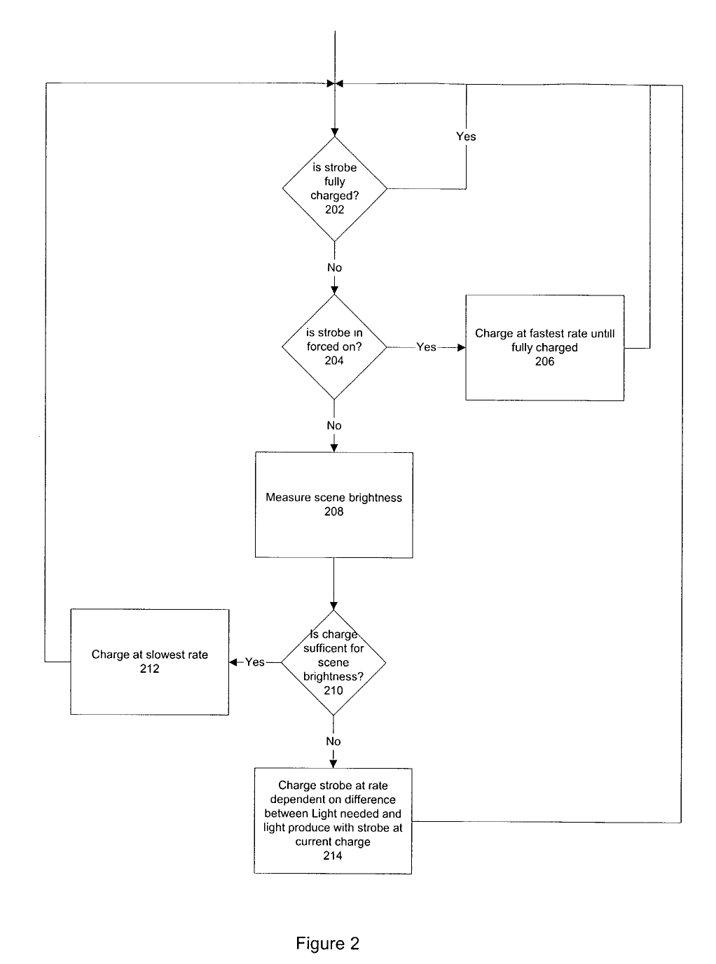

### DETAILED DESCRIPTION OF THE PREFERRED EMBODIMENT

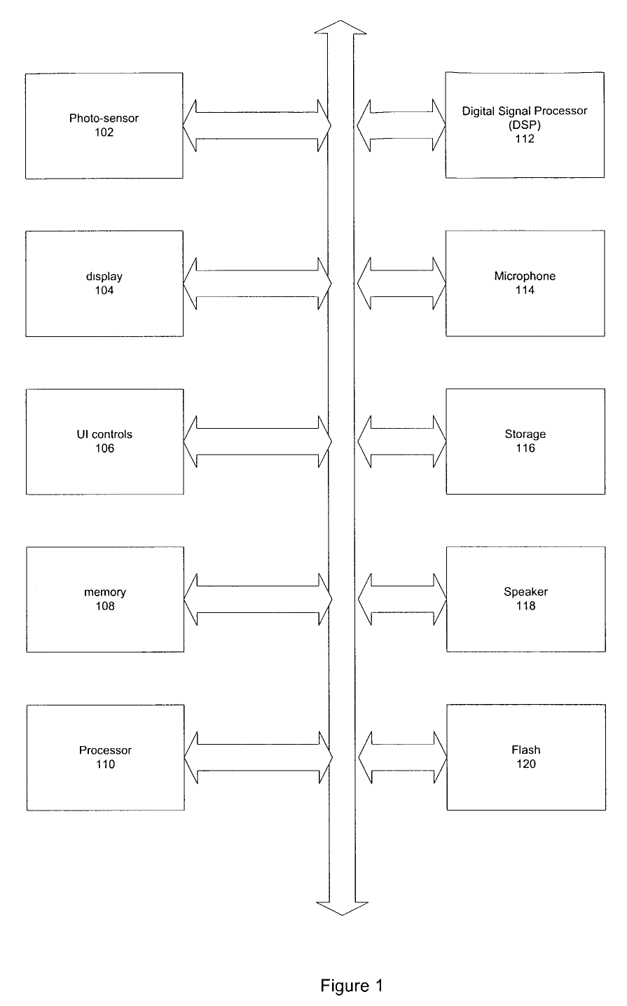

A block diagram of a typical digital imaging device is show in FIG. 1. A lens (not shown) is used to form an image on a photo-sensor (102). A processor may be used to measure the brightness of the image captured by the photo-sensor (102). The processor used to measure the brightness may be a general-purpose processor, for example processor (110), or it may be a special purpose processor, for example digital signal processor (112). The brightness of the scene could also be measured by using hardware attached or built into the photo sensor. Today, most digital imaging devices have a flash (120) that operates in at least two modes. One mode is “forced on” mode, and the other mode is “flash as needed” mode. A user typically selects a flash mode by using the UI controls (106). The user could also turn the flash off. Once the user has selected the flash mode, the digital imaging device will operate the flash in that mode. In any of the flash enabled modes, the strobe typically produces a variable amount of light, dependent on the measured scene brightness. Independent of the flash enabled mode, the digital imaging device will typically charge the strobe capacitor at the same charge rate until the capacitor is fully charged. This may needlessly stress the batteries when the capacitor already has the required energy to properly illuminate the scene.

In one example embodiment of the current invention, the digital imaging device would determine if the flash were enabled. If so, the device would check to see if the capacitor were fully charged (202). In the event that the capacitor were fully charged, no action would be required. Otherwise, the device checks to see if the “forced on” mode were selected (204). In the event that the “forced on” mode were selected, the capacitor is charged at the fastest rate until fully charged (206). As one skilled in the art will appreciate, the order of these steps could be reversed such that the device could first check to see if the “forced on” mode were selected and then check to see if the capacitor were fully charged.

In the event that the capacitor were not fully charged and the strobe were not in the “forced on” mode, the device would measure the current scene brightness (208). The amount of light that could be produced by the strobe using the current charge is compared with the amount of light required by the scene (210). When the current charge could produce sufficient light for the scene, the capacitor is charged at a slow rate (212), which is less stressful to the batteries than a high charge rate. (In another example embodiment, when the current charge could produce sufficient light for the scene, no action would be taken.) When the current charge could not produce sufficient light for the scene, the capacitor is charged at a rate dependent on the difference between the light needed and the amount of light producible by the strobe using the current charge (214). For example, when the current charge could almost produce enough light, the charge rate would be slow. When the current charge could produce only a small fraction of the light needed, the charge rate would be high.

In one example embodiment, the device could have a number of discreet charge rates. The device would choose which charge rate to use based on the difference between the available light and the required light (the available light referring to the amount of additional light that could be produced by the strobe using the current charge in the capacitor). For example, the device could have three different charge rates: slow, medium, and fast. The device would use the slow charge rate when the available light were more than ⅔ of the required light. The device would use the fast charge rate when the available light were less than ⅓ the required light. Finally, the device would use the medium charge rate when the available light were between ⅓ and ⅔ of the required light. In this example, three charge rates were described and the difference between the available light and the required light were divided equally between the three charge rates. This invention is not limited to three charge rates, nor to equally dividing the range between the available light and the required light.

In another example embodiment of the current invention, the charge rate could be a continuous range of rates. For example, the charge rate could equal the percentage difference between the available light and the required light (i.e., when the available light was only 50% of the required light, the charge rate would be 50% of the maximum charge rate). The relationship between the charge rate and the difference between the available light and the required light does not need to be linear.

In most automatic cameras, the shutter button has three positions. The first position is when the button is pressed half way down (typically called the S1 position). In this position the camera runs its auto-focus and auto-exposure routines. Typically the user depresses the shutter button to the S1 position just prior to taking a picture. The second position is when the button is fully depressed. At this position the camera initiates its exposure routine for capturing the image. The third position is the un-pressed position. In another example embodiment of the current invention, the charging rate for the strobe energy storage device would switch into the fastest rate whenever the shutter button was depressed to the S1 position. In another example embodiment, the charging rate would switch into the fastest charging rate when the shutter button was depressed to the S1 position and the current charge was not sufficient to provide the needed illumination for the scene.

In another example embodiment of the current invention, the charge rate would take into account the battery condition. For example, when the battery was low, the charge rate used would be a slow charge rate. Using a slow charge rate when the battery is low may allow the user to take a picture, where a fast charge rate would have drained the battery and prevented the user from taking a picture.

In the example embodiments above, a digital imaging device is used to explain the current invention. However, as one skilled in the arts would appreciate, this invention is not limited in use to only digital imaging devices. For example, a flash accessory could use this invention. The flash accessory could have a built in device for measuring scene brightness. In this configuration, the flash could be used on both a digital imaging device or a film camera. In another configuration, the flash could use a sensor external to the flash, for example one built into the device attached to the flash. In another example embodiment, a traditional film camera may have a photo sensor and a flash built into the camera. The flash in the traditional film camera can use this invention to automatically switch between charge rates for its built-in flash.

The foregoing description of the present invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method of charging a strobe, comprising:
determining the illumination required for a scene;
determining the amount of illumination the strobe can produce by detecting the current charge level of the strobe's energy storage device;
charging the strobe's energy storage device using a charge rate based on the difference between the illumination required in the scene and the amount of illumination the strobe can produce with the current charge level.

2. The method of claim 1 where the energy storage device is a capacitor.

3. The method of claim 1 where there are a limited number of discrete charge rates.

4. The method of claim 1 where there are an unlimited number of continuous charge rates.

5. The method of claim 1 where the charge rate used is the slowest charge rate when the strobe's energy storage device already has sufficient energy to provide the needed illumination for the scene.

6. The method of claim 1 where the strobe's energy storage device is not charged when the strobe's energy storage device already has sufficient energy to provide the needed illumination for the scene.

7. The method of claim 1 where the charge rate used is the fastest charge rate when the shutter button is in the S1 position.

8. The method of claim 1 where the charge rate used is the fastest charge rate when the shutter button is in the S1 position and there is insufficient energy in the strobe's energy storage device to provide the needed illumination for the scene.

9. The method of claim 1 where the charge rate used is the slowest charge rate when the battery is low.

10. A digital imaging device, comprising:
a photo-sensor used to capture the illumination of a scene;
a strobe light used to provide added illumination to the scene;
an energy storage device used to generate illumination via the strobe light, the energy storage device having a current charge level;
a processor configured to measure the required illumination using the captured illumination in the scene;
the processor configured to vary the charging rate of the energy storage device based on the difference between the required illumination of the scene and the amount of illumination the strobe could generate using the current charge in the energy storage device.

11. The digital imaging device of claim 10 where the energy storage device is a capacitor.

12. The digital imaging device of claim 10 where the charge rate used is the slowest charge rate when the strobe's energy storage device already has sufficient energy to provide the needed illumination for the scene.

13. The digital imaging device of claim 10 where the strobe's energy storage device is not charged at all when the strobe's energy storage device already has sufficient energy to provide the needed illumination for the scene.

14. The digital imaging device of claim 10 further comprising:
a shutter button, where the charge rate used is the fastest charge rate when the shutter button is in the S1 position.

15. The digital imaging device of claim 10 further comprising:
a shutter button, where the charge rate used is the fastest charge rate when the shutter button is in the S1 position and there is insufficient energy in the strobe's energy storage device to provide the needed illumination for the scene.

16. The digital imaging device of claim 10 further comprising:
a battery, where the charge rate used is the slowest charge rate when the charge of the battery is low.

17. A digital imaging device, comprising:
a photo-sensor used to measure the illumination of a scene;
a strobe light used to provide added illumination to the scene;
an energy storage device used to generate illumination via the strobe light, the energy storage device having a current charge level;
a processor configured to vary the charging rate of the energy storage device based on the difference between the required illumination of the scene and the amount of illumination the strobe could generate using the current charge in the energy storage device.

18. A method of charging a strobe, comprising:
determining the current strobe operating mode;
charging the strobe at the fastest charge rate when the strobe is in the forced on mode, otherwise;
measuring the scene brightness to determine the illumination required;
determining the additional illumination available by detecting the current charge level for the strobe;
charging the strobe using a rate dependent on the difference between the illumination required and the illumination available.

19. A strobe, comprising:
a photo-sensor used to capture the illumination of a scene;
a flash tube used to generate light;
an energy storage device used to power the flash tube, the energy storage device having a current charge level;
a processor configured to measure the required illumination of the captured illumination of the scene;
the processor configured to vary the charging rate of the energy storage device based on the difference between the required illumination of the scene and the amount of light the flash tube could generate using the current charge in the energy storage device.

20. A strobe, comprising:
a photo-sensor used to measure the illumination of a scene;
a flash tube used to generate light;
an energy storage device used to power the flash tube, the energy storage device having a current charge level;
a processor configured to vary the charging rate of the energy storage device based on the difference between the required illumination of the scene and the amount of light the flash tube could generate using the current charge in the energy storage device.

21. A digital imaging device, comprising:
a means for measuring the required illumination of a scene;
a strobe for adding illumination to the scene;
a means for storing energy to be used by the strobe;
a means for varying the replenishment rate of the stored energy based on the difference between the required illumination of the scene and the amount of light the strobe could generate using the current amount of stored energy.

22. A camera, comprising:
a means for measuring the required illumination of a scene;
a strobe for adding illumination to the scene;
a means for storing energy to be used by the strobe;
a means for varying the replenishment rate of the stored energy based on the difference between the required illumination of the scene and the amount of light the strobe could generate using the current amount of stored energy.
